(19) United States
(12) Patent Application Publication
(10) Pub. No.: US 2016/0248179 A1
(43) Pub. Date: Aug. 25, 2016

(54) CABLE OR CONDUIT CONNECTOR WITH JACKET RETENTION FEATURE

(71) Applicant: Corning Optical Communications RF LLC, Glendale, AZ (US)

(72) Inventors: Donald Andrew Burris, Peoria, AZ (US); Thomas Dewey Miller, Peoria, AZ (US)

(21) Appl. No.: 14/797,575

(22) Filed: Jul. 13, 2015

Related U.S. Application Data
(60) Provisional application No. 62/118,598, filed on Feb. 20, 2015.

(51) Int. Cl. H01R 9/05; H01R 43/16

(52) U.S. Cl. CPC H01R 9/0521; H01R 43/16

(57) ABSTRACT

Connectors and methods for attaching connectors to one or more cables and/or conduits are disclosed. The disclosed connectors and methods may secure an outer surface of the cable (e.g., an outer jacket of a cable) or conduit. A front coupler sleeve engages a sub-assembly comprising a back coupler sleeve and an actuator sleeve disposed around the cable or conduit. During engagement of an inner surface of the front coupler sleeve and an outer surface of the back coupler sleeve, an at least partially annular protrusion of the back coupler sleeve is displaced radially inwardly to secure the outer surface of the cable or conduit.

### RELATED APPLICATIONS

This application claims the benefit of priority under 35 U.S.C. §119 of U.S. Provisional Application No. 62/118,598 filed on Feb. 20, 2015, the content of which is relied upon and incorporated herein by reference in its entirety.

### BACKGROUND

1. Field

The present disclosure generally relates to coaxial cable connectors.

2. Technical Background

A coaxial cable includes an inner conductor, a dielectric surrounding the inner conductor, an outer conductor surrounding the dielectric and an outer jacket. In some circumstances, it may be desirable to separate and remove the dielectric and inner conductor from the outer conductor of the coaxial cable. For example, in situations where new fiber optic cable is to be laid in a neighborhood with an existing coaxial cable infrastructure, it may be less expensive and quicker to run the fiber optic cable through the existing coaxial cable infrastructure. In order to run fiber optic cable through an existing coaxial cable infrastructure, the dielectric and inner conductor must be separated and removed from the outer conductor, leaving behind the outer conductor surrounded by an outer jacket through which the fiber optic cable may be installed.

Accordingly, a need exists for connectors used for removing a cable core from a coaxial cable and/or attaching a coaxial cable outer conductor and jacket from which a cable core has been removed.

### SUMMARY

Connectors are provided for use in removing a cable core from a coaxial hardline cable and for attaching a thin-wall coaxial cable outer conductor and jacket from which a cable core has been removed. In some embodiments, connectors may function with various aspects of a cable core removal process and/or replacement of a cable core with fiber optical cables.

In one embodiment, a connector for securing an outer surface of a cable or conduit is provided. The connector includes a back coupler sleeve, an actuator sleeve and a front coupler sleeve. The back coupler sleeve includes at least one inner surface defining a back coupler sleeve opening extending through the back coupler sleeve and an outer surface. The back coupler sleeve also includes at least a partial annular ring formed along the inner surface within the back coupler sleeve opening. The connector also includes an actuator sleeve including an inner surface defining an actuator sleeve opening extending through the actuator and adapted to receive the cable, the inner surface including a tapered portion adapted to at least partially receive the annular ring of the back coupler sleeve within the actuator sleeve opening, the actuator sleeve inserted into the back coupler sleeve opening of the back coupler sleeve and disposed adjacent to the annular ring of the back coupler sleeve; and a front coupler sleeve comprising an inner surface disposed about at least a portion of the outer surface of the back coupler sleeve and adapted to engage the outer surface of the back coupler sleeve, wherein engagement of inner surface of the front coupler sleeve and the outer surface of the back coupler sleeve is adapted to displace the annular ring of the back coupler sleeve radially inwardly to secure the outer surface of the cable or conduit.

In another embodiment, a method for securing a cable or conduit in a connector is provided. In the method, an actuator sleeve is inserted into an opening of a back coupler sleeve. The back coupler sleeve includes at least one inner surface defining the opening of the back coupler sleeve, an outer surface and an at least partially annular protrusion formed along the inner surface within the back coupler sleeve opening. The actuator sleeve includes an inner surface defining an actuator sleeve opening extending through the actuator and adapted to receive the cable or conduit. The inner surface includes a tapered portion adapted to at least partially receive the annular protrusion of the back coupler sleeve within the actuator sleeve opening. The actuator sleeve is inserted into the back coupler sleeve opening of the back coupler sleeve and disposed adjacent to the annular ring of the back coupler sleeve. A cable or conduit is extended within the opening of the back coupler sleeve and the opening of the actuator sleeve. At least a portion of the outer surface of the back coupler sleeve is extended within an inner surface of a front coupler sleeve. The operation of engaging the inner surface of the front coupler sleeve and the outer surface of the back coupler sleeve displaces the at least partially annular protrusion of the back coupler sleeve radially inwardly to secure the outer surface of the cable or conduit.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a partial cross sectional view of a coaxial cable, according to one or more embodiments shown and described herein;

FIG. 2 schematically depicts a partial cross-sectional view of a typical hardline coaxial cable connector 200, according to one or more embodiments shown and described herein;

FIG. 3 schematically depicts a partial cross sectional view of the hardline coaxial cable connector shown in FIG. 2 in which the outer jacket of the coaxial cable is pulled back along the outside of outer conductor, according to one or more embodiments shown and described herein;

FIG. 4 schematically depicts an exploded view of components of an example embodiment of a cable connector is depicted with the individual components shown in cross-section, according to one or more embodiments shown and described herein;

FIG. 5 schematically depicts a cross-sectional view of the packing nut shown in FIG. 4, according to one or more embodiments shown and described herein;

FIG. 6 schematically depicts a cross-sectional view of the packing shown in FIG. 4, according to one or more embodiments shown and described herein;

FIG. 7 schematically depicts a cross-sectional view of the main nut shown in FIG. 4, according to one or more embodiments shown and described herein;

FIG. 8 schematically depicts a cross-sectional view of the actuator of the sub-assembly shown in FIG. 4, according to one or more embodiments shown and described herein;

FIG. 9 schematically depicts a cross-sectional view of the back nut of the sub-assembly shown in FIG. 4, according to one or more embodiments shown and described herein;

FIG. 10 schematically depicts a cross-sectional view of the sub-assembly shown in FIG. 4 having coaxial cable inserted therethrough, according to one or more embodiments shown and described herein;

FIG. 11 schematically depicts a cross-sectional view of the sub-assembly shown in FIG. 4 having coaxial cable inserted therethrough, according to one or more embodiments shown and described herein;

FIG. 12 schematically depicts a cross-sectional view of a fluid adaptor, a main nut and a sub-assembly, according to one or more embodiments shown and described herein;

FIG. 13 schematically depicts a cross-sectional view of the fluid adaptor engaged with the cable connector of FIG. 10, according to one or more embodiments shown and described herein;

FIG. 14 schematically depicts a schematic cross-sectional view of a tubing, the packing nut and the packing introduced in preparation for engagement with the main nut, the back nut and installed coaxial cable, according to one or more embodiments shown and described herein;

FIG. 15 schematically depicts a partial cross-sectional view of a completed feed-through assembly wherein the tubing has been inserted through a through-bore of the packing nut, an opening of the packing and the inside of the outer conductor, according to one or more embodiment shown and described herein;

FIG. 16 schematically depicts a partial cross sectional view of a completed feed-through assembly of FIG. 15 having a ground wire installed in a bonding port of the back nut, according to one or more embodiments shown and described herein;

FIG. 17 schematically depicts a cross-sectional view of the sub-assembly in an uncompressed condition about a cable, according to one or more embodiments shown and described herein;

FIG. 18A schematically depicts an end view of the ferrule of FIG. 17, according to one or more embodiments shown and described herein;

FIG. 18B schematically depicts a cross sectional view of ferrule of FIG. 17, according to one or more embodiments shown and described herein;

FIG. 19 schematically depicts a cross-sectional view of the sub-assembly of FIG. 17 in a compressed condition about a cable, according to one or more embodiments shown and described herein;

FIG. 20 schematically depicts a cross-sectional view of an alternative embodiment of a sub-assembly in an uncompressed condition about a cable, according to one or more embodiments shown and described herein;

FIG. 21A depicts an end view of the actuator sleeve of FIG. 20, according to one or more embodiments shown and described herein;

FIG. 21B schematically depicts a cross-sectional view of the actuator sleeve of FIG. 20, according to one or more embodiments shown and described herein;

FIG. 22 schematically depicts a cross sectional view of the sub-assembly of FIG. 20 in a compressed condition about a cable, according to one or more embodiments shown and described herein;

FIG. 23 schematically depicts a cross-sectional view of another embodiment of a sub-assembly in an uncompressed condition about a cable, according to one or more embodiments shown and described herein;

FIG. 24A schematically depicts an end view of the collapsible ring of FIG. 23, according to one or more embodiments shown and described herein;

FIG. 24B schematically depicts a cross-sectional view of the collapsible ring of FIG. 23, according to one or more embodiments shown and described herein;

FIG. 25 schematically depicts a cross-sectional view of the sub-assembly of FIG. 23 in a compressed condition about a cable, according to one or more embodiments shown and described herein;

FIG. 26 schematically depicts a cross-sectional view of another embodiment of a sub-assembly in an uncompressed condition about a cable, according to one or more embodiments shown and described herein;

FIG. 27A schematically depicts an end view of the ring of FIG. 26, according to one or more embodiments shown and described herein;

FIG. 27B is a cross-sectional view of the ring of FIG. 26, according to one or more embodiments shown and described herein;

FIG. 28 schematically depicts a cross-sectional view of the sub-assembly shown in FIG. 26 in a compressed condition about a cable, according to one or more embodiments shown and described herein;

FIG. 29 schematically depicts a partial cross-sectional view of an alternate embodiment of a completed feed-through connector assembly, according to one or more embodiments shown and described herein;

FIG. 30 schematically depicts a cross-sectional view showing a sub-assembly having a coaxial cable inserted therethrough, according to one or more embodiments shown and described herein;

FIG. 31 schematically depicts a cross-sectional view fluid adaptor engaged with the connection system of FIG. 30 by means of threaded portions of fluid adaptor and threaded portion of splice main nut, according to one or more embodiments shown and described herein;

FIG. 32 schematically depicts a partial cross-sectional view of a completed splice assembly comprising two sub-assemblies 600 and a splice main nut, according to one or more embodiments shown and described herein;

FIG. 33 schematically depicts a partial cross-sectional view of a three piece hardline coaxial pin type connector with having a jacket retention mechanism as described above with respect to FIGS. 4-10 in which a back coupler sleeve/nut is a not fully tightened condition, according to one or more embodiments shown and described herein;

FIG. 34 schematically depicts a partial cross-sectional view of the three piece hardline coaxial pin type connector shown in FIG. 33 with the jacket retention mechanism having a back nut in a tightened condition, according to one or more embodiments shown and described herein; and

FIG. 35 schematically depicts a partial cross-sectional view of a three piece hardline coaxial splice type connector with a jacket retention mechanism as described above with respect to FIGS. 4-10 in which a back coupler sleeve/nut is in a tightened condition, according to one or more embodiments shown and described herein.

### DETAILED DESCRIPTION

Embodiments of the present disclosure are directed to connectors for use with one or more cables and/or conduits. In one embodiment, for example, a connector may be used in removing a cable core from a coaxial hardline cable and to secure a thin-wall coaxial cable outer conductor and jacket from which a cable core has been removed. In some embodiments, connectors may function with various aspects of a cable core removal process and/or replacement of a cable core with fiber optical cables. In various embodiments, connectors provided herein may also be used with standard coaxial cables as well. In other embodiments, a connector may be used to secure an outer surface of a conduit through which one or more cables (e.g., fiber optic cables) may be routed.

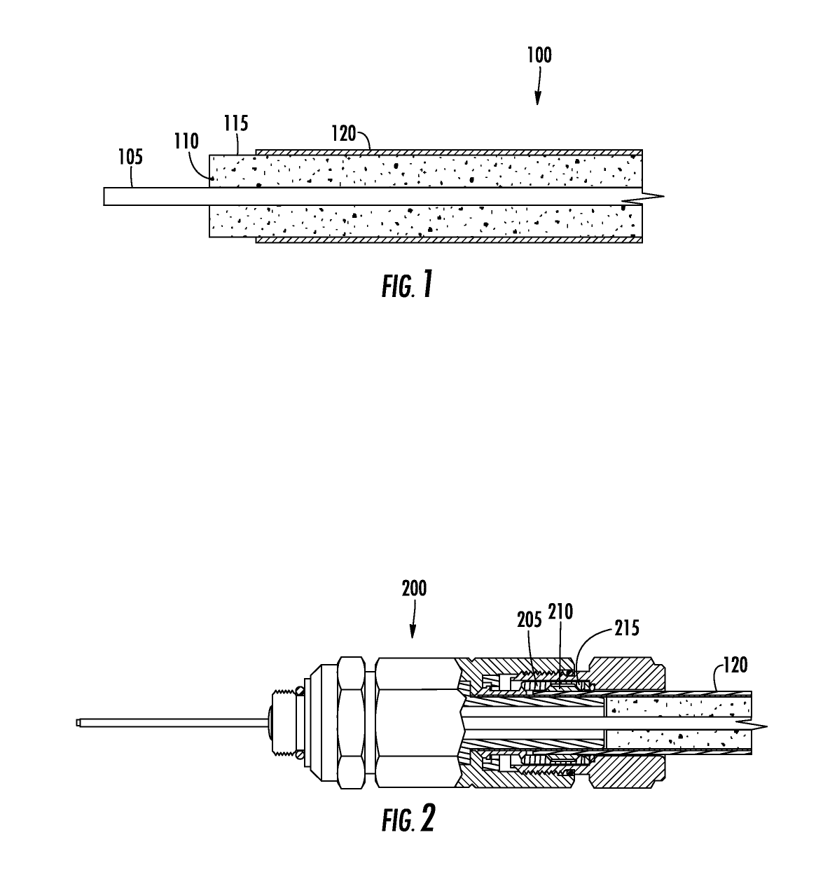

Referring now to FIG. 1, a coaxial cable 100 is schematically depicted. The coaxial cable 100 includes an inner conductor 105, a dielectric 110, and an outer conductor 115. The dielectric 110 surrounds the inner conductor 105. The outer conductor 115 surrounds the dielectric 110. In some embodiments the inner conductor 105 is copper-clad aluminum, though the inner conductor 105 may be a conductor other than copper-clad aluminum (e.g., copper, gold, or the like) in other embodiments. In some embodiments, the dielectric 110 is a plastic, though the dielectric 110 may be an insulator other than plastic in other embodiments. In some embodiments, the outer conductor 115 is aluminum, though the outer conductor 115 may be a conductor other than aluminum in other embodiments. The coaxial cable 100 further includes an outer jacket 120. In some embodiments, the outer jacket 120 is an insulator, such as, but not limited to plastic. The outer jacket 120 may comprise, for example, polyethylene and/or other plastic.

Referring now to FIG. 2, a partial cross-sectional view of a typical hardline coaxial cable connector 200 is depicted. The coaxial cable connector 200 is attached to a coaxial cable 100, such as shown in FIG. 1. Compression rings 205 and 215 of the coaxial connector 200 are axially moved toward each other. The compression rings 205 and 215 drive a ferrule 210 radially inwardly to clamp against the outer jacket 120 of the coaxial cable 100. This clamping action serves to anchor outer jacket 120 within connector 200 and is intended to prevent outer jacket 120 from sliding along the outside of outer conductor 115 away from connector 200 due to contractive movement caused by exposure to cold weather conditions.

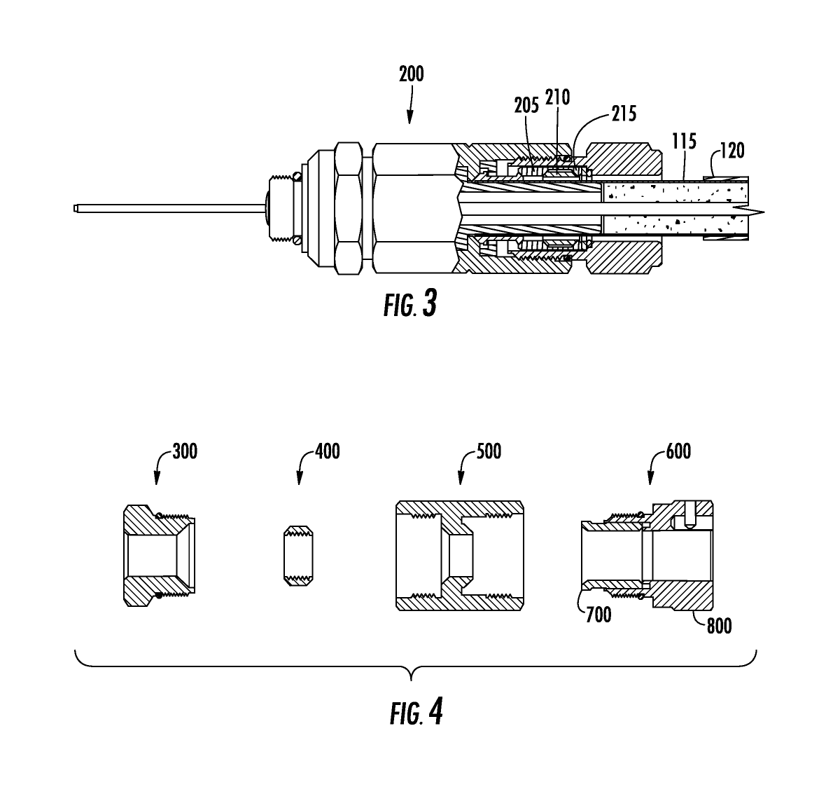

FIG. 3 depicts a partial cross sectional view of the hardline coaxial cable connector 200 shown in FIG. 2 in which the outer jacket 120 of the coaxial cable 100 is pulled back along the outside of outer conductor 115. The outer jacket 120 is shown pulled away from connector 200, such as might occur due to contractive movement caused by exposure to cold weather conditions and a failure of the ferrule 210. In FIG. 3, the outer conductor 115 is shown exposed to the elements and the jacket 120 no longer supports coaxial cable 100 within the connector 200. In this condition, moisture and debris may enter the connector/cable junction and outer conductor 115 may be subjected to cracking caused by bending and vibration.

Referring now to FIG. 4, an exploded view of components of an example embodiment of a cable connector 250 is depicted with the individual components shown in cross-section. In this embodiment, the cable connector 250 comprises a packing coupler sleeve or nut 300, a packing sleeve 400, a main/front coupler sleeve or nut 500, and a sub-assembly 600 that interact together to grasp an outer jacket of a cable, such as the coaxial cable 100 shown in FIG. 1. The sub-assembly 600, in this embodiment, includes an actuator sleeve 700 assembled with a back coupler sleeve/nut 800. The individual packing coupler sleeve or nut 300, packing sleeve 400, main/front sleeve or nut 500 and sub-assembly 600 components of the cable connector 250 are further described with reference to FIGS. 5 through 10.

Referring now to FIG. 5, a cross-sectional view of the packing coupler sleeve or nut 300 shown in FIG. 4 is depicted. The packing coupler sleeve/nut 300 may be constructed of a conductor, such as aluminum. The packing nut 300 may also be finished with a coating, such as an iridite coating and dry-lube. In this embodiment, the packing nut 300 comprises a front end 305 and a back end 330. A through-bore 315 extends through packing nut 300 between the front end 305 and the back end 330. A front portion of the through-bore is defined by a conical portion 310 that extends axially from the front end 305. A threaded portion 320 is disposed along an exterior surface 335 of the packing nut 300. In the embodiment shown in FIG. 5, an O-ring 325 is also shown disposed along the exterior surface 335 of the packing nut 300 rearward of and adjacent to the threaded portion 320 of the packing nut 300. Although the packing nut 300 is shown in FIG. 5 as including the O-ring 325, the packing nut may not include an O-ring and/or may include another type of sealing mechanism.

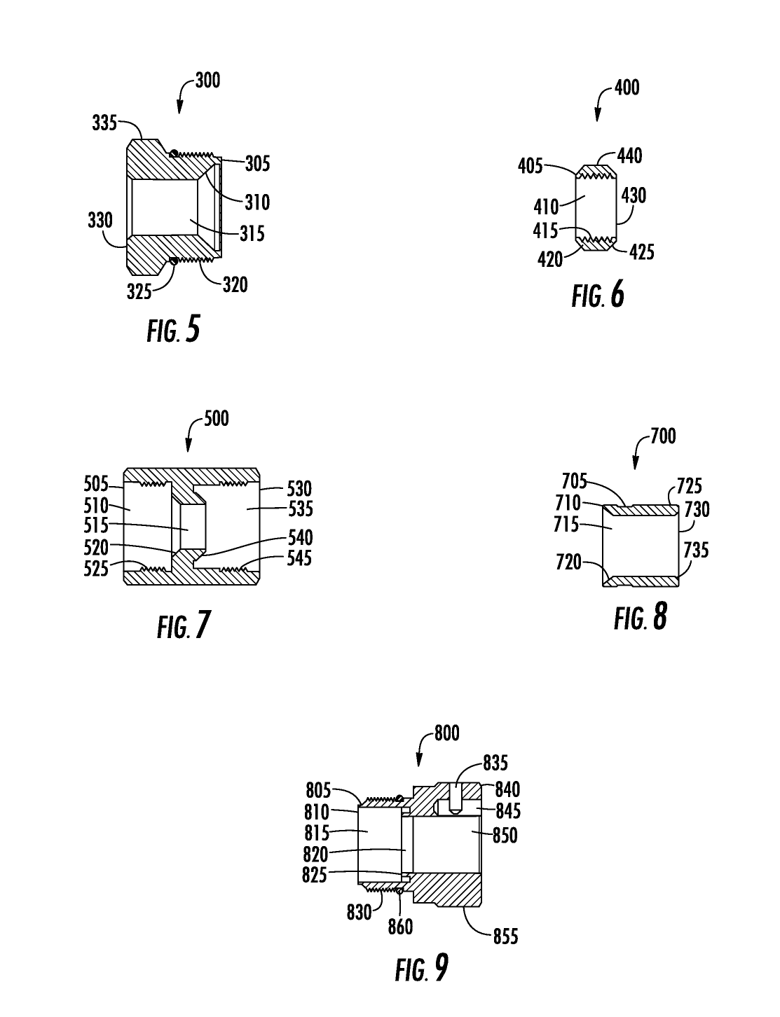

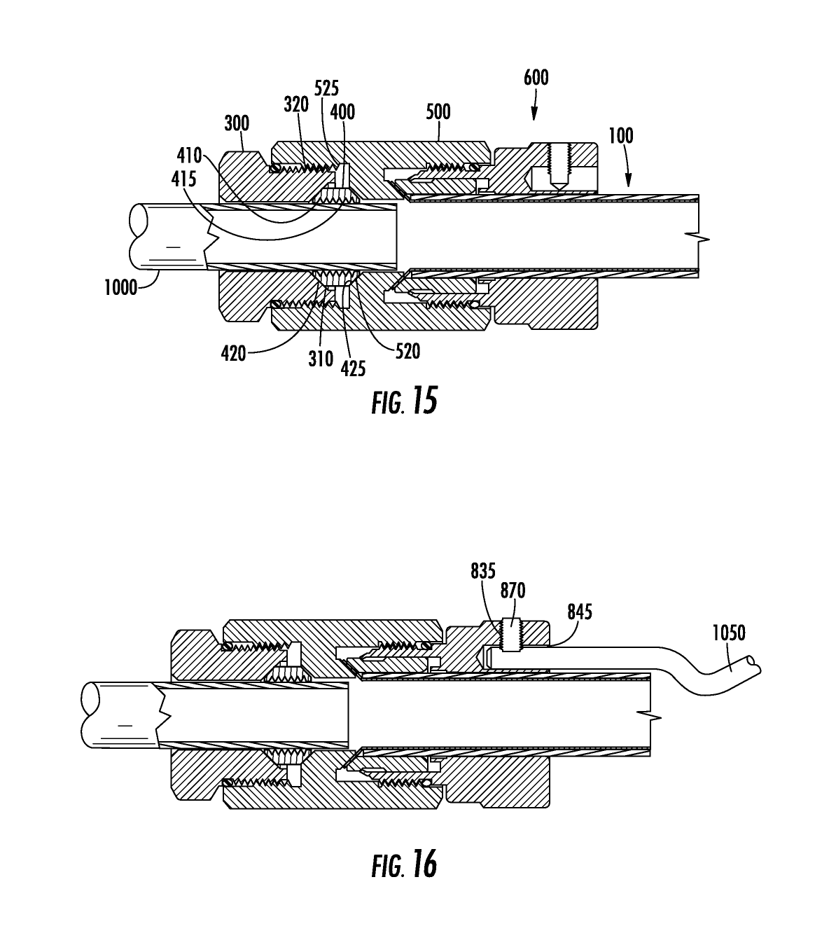

Referring now to FIG. 6, a cross-sectional view of the packing sleeve 400 shown in FIG. 4 is depicted. The packing sleeve 400, for example, may be constructed of an insulator, such as a plastic material (e.g., acetal). In this embodiment, the packing sleeve 400 comprises a back end 405, a front end 430 and an opening extending through the packing sleeve 400 between the back end 405 and the front end 430. A plurality of grooves or ridges 415 are formed along an interior surface of the packing sleeve 400 and are adapted for gripping a cable jacket or tubing as described below with reference to FIG. 15. The packing sleeve 400 further comprises a back tapered portion 420 and a front tapered portion 425. The back tapered portion 420 is formed along an exterior surface 440 of the packing sleeve 400 and extends from the back end 405 of the packing sleeve 400. The front tapered portion 425 is formed along the exterior surface 440 of the packing sleeve 400 extending from the front end of the packing sleeve 400.

Referring now to FIG. 7, a cross-sectional view of the main/front coupler sleeve/nut 500 shown in FIG. 4 is depicted. In this embodiment, the main coupler sleeve/nut 500 may be constructed of a conductor, such as aluminum. The main nut 500 may also be finished with a coating, such as an iridite coating and dry-lube. The main nut 500 comprises a front end 505, a back end 530 and a through-bore 515 extending through the main nut 500 between the front end 505 and the back end 530. The through-bore 515 includes a first, front opening 510 extending from the front end 505, a second, back opening 535 extending from the back end 530, and a central opening extending between the first, front opening 510 and the second, back opening 535. The central opening includes a conical portion 520 extending away from the first, front opening 510 toward the second, back opening 535. A first, front threaded portion 525 is formed along an interior surface of the main nut 500 within at least a portion of the first, front opening 510. A second, back threaded portion 545 is formed along an interior surface of the main nut 500 within at least a portion of the second, back opening 535. The main nut 500 further includes a frustoconical portion 540 formed within the through-bore 515.

FIG. 8 depicts a cross-sectional view of the actuator sleeve 700 of the sub-assembly 600 shown in FIG. 4. The actuator sleeve 700 may be constructed of a conductor, such as aluminum. The actuator sleeve 700 may also be finished with a coating, such as an iridite coating and dry-lube. In this embodiment, the actuator sleeve 700 comprises a front end 710, a back end 730 and a passage 715 defined by an interior surface of the actuator sleeve 700 and extending through the actuator sleeve 700 between the front end 710 and the back end 730. The actuator sleeve 700 further comprise a recess 705 formed in an exterior surface 725 of the actuator sleeve 700. In this embodiment, the interior surface of the actuator sleeve 700 includes a first, front tapered surface 720 extending in a rearward direction away from the front end 710 and a second, back tapered surface 735 extending in a frontward direction away from the back end 730.

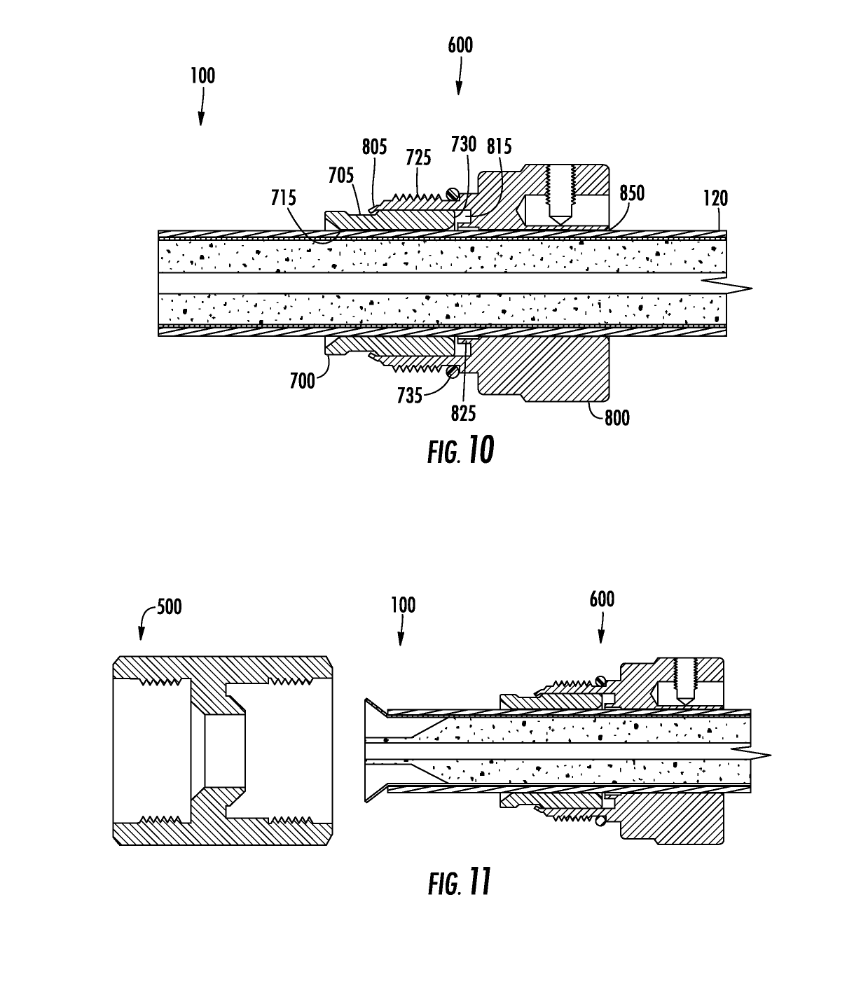

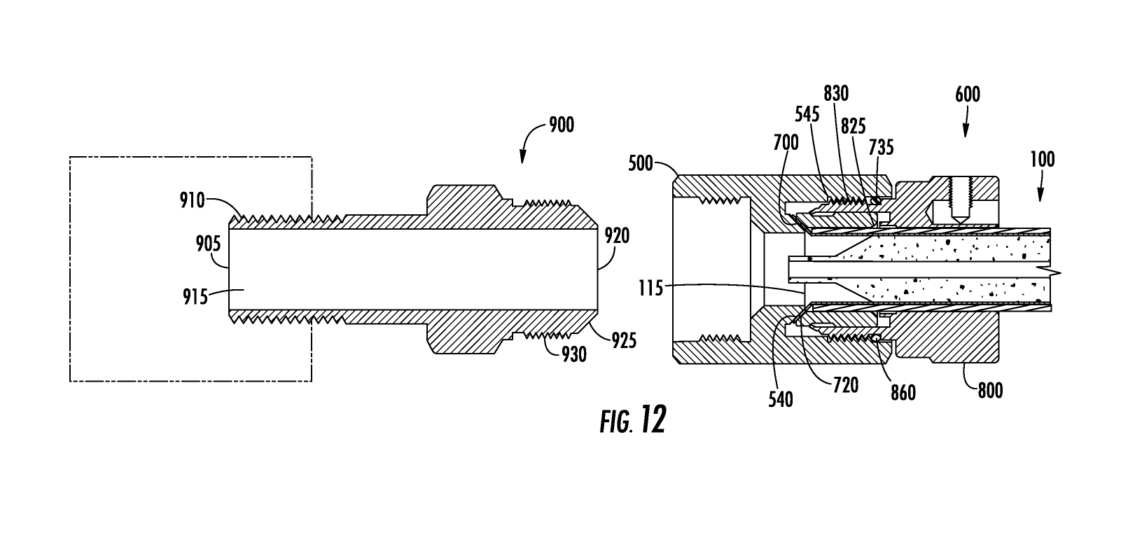

FIG. 9 depicts a cross-sectional view of the back coupler sleeve/nut 800 of the sub-assembly 600 shown in FIG. 4. The back coupler sleeve/nut 800 may be constructed of a conductor, such as aluminum. The back coupler sleeve/nut 800 may also be finished with a coating, such as an iridite coating and dry-lube. In this embodiment, the back nut 800 includes a front end 810, a back end 840 and an opening 815 extending through the back nut between the front end 810 and the back end 840. The opening 815 includes a front bore 820 and a back bore 850. A front lip 805 is formed along an exterior surface 855 of the back nut 800 at or adjacent to the front end 810. An external threaded portion 830 is formed along the exterior surface 855 extending in a rearward direction away from the front lip 805. An annular ring 825 is also formed within the opening 815 of the back nut 800. In various embodiments, the annular ring may comprise at least a partial annular ring that extends partially or completely around the interior surface of the back coupler sleeve/nut 800.

In the particular embodiment shown in FIG. 9, the back nut 800 further includes a threaded hole 835 adapted to receive a set screw. A bonding port 845 is also formed in an axial direction between the exterior and interior surfaces of the back nut 800 extending from the back end 840. In the particular embodiment shown in FIG. 9, an O-ring 860 is disposed adjacent the threaded portion 830 extending around the exterior surface 855 of the back nut 800. The back nut 800, however, may be constructed without an O-ring 860 or may include a different sealing device than the O-ring 860 shown.

FIG. 10 depicts a cross-sectional view of the sub-assembly 600 shown in FIG. 4 having coaxial cable 100 inserted therethrough. In the embodiment shown in FIG. 10, the sub-assembly 600 includes the actuator sleeve 700 inserted into an opening 815 of the back nut 800. An exterior surface 725 of the actuator sleeve 700 is sized such that there is radial clearance between the exterior surface 725 of the actuator sleeve 700 and the opening 815 of the back nut 800 allowing movement between actuator sleeve 700 and back nut 800. The lip 805 of back nut 800, in this embodiment, is rolled radially inwardly about the circumference of recess 705 of actuator sleeve 700 thus limiting axial movement of the actuator sleeve 700 within opening 815 and prevents separation of the actuator sleeve 700 from the back nut 800. In this condition, the back end 730 and, more specifically, the tapered surface 735 of the actuator sleeve 700 are allowed clearance from the annular ring 825 of the back nut 800. The passage 715 of the actuator sleeve 700 and the through-bore 850 of the back nut 800 are sized to provide clearance between actuator sleeve 700, back nut 800 and cable jacket 120 of cable 100. As such, in this embodiment, the sub assembly 600 is free to slide along cable 100 in an unimpeded manner.

FIG. 11 depicts a cross-sectional view of the sub-assembly 600 having a coaxial cable 100 inserted therethrough. In the FIG. 11, the coaxial cable 100 has been prepared and flared for removal of the cable dielectric material 110 and the inner conductor 105. The main/front nut 500 is introduced in preparation for assembly with the sub-assembly 600 as described below with reference to FIG. 12.

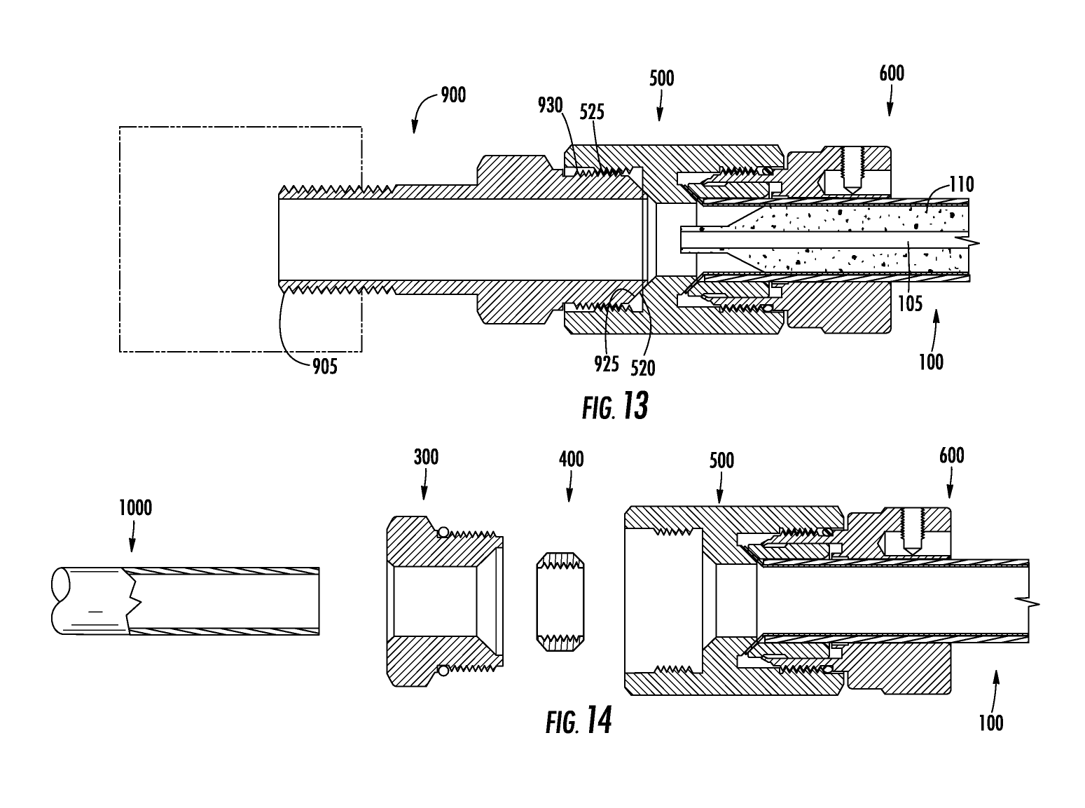

FIG. 12 depicts a cross-sectional view of a fluid adaptor 900 being introduced in preparation for assembly with the main nut 500 and the sub-assembly 600. In this embodiment, the main nut 500 is assembled with the sub-assembly 600 by engaging a threaded portion 545 of the main nut 500 with a threaded portion 830 of the back nut 800. A coaxial cable outer conductor 115 is captured between a frustoconical portion 540 of the main nut 500 and the tapered surface 720 of actuator sleeve 700 providing mechanical, environmental, and pressure sealing. Additionally, the capturing of cable outer conductor 115 between frustoconical portion 540 of main nut 500 and tapered surface 720 of actuator sleeve 700 provides an electrical ground path between the coaxial cable 100 outer conductor 115 and the connector. Further, engagement of the threaded portion 545 of the main nut 500 and the threaded portion 830 of the back nut 800 drives the back nut 800 axially forward in relation to the actuator sleeve 700 causing the annular ring 825 of the back nut 800 to be forced against the tapered surface 735 of actuator sleeve 700. Yet further engagement of threaded portion 545 of the main nut 500 and the threaded portion 830 of the back nut 800 drives the annular ring 825 radially inwardly along a contour of the tapered surface 735 of the actuator sleeve 700 causing the annular ring 825 to close about and at least partially circumferentially indent or dig/press into the outer jacket 120 of the coaxial cable 100 both grasping the coaxial cable outer jacket 120 to prevent it from unwanted rearward movement under temperature extremes and sealing the junction between cable jacket 120 and the annular ring 825 of the back nut 800 against moisture ingress. Various embodiments may be constructed with or without the O-ring 860. In one embodiment, for example, the fluid adaptor 900 is introduced into the connector in preparation for the next step of the process as seen in FIG. 13.

FIG. 13 depicts a cross-sectional view of the fluid adaptor 900 engaged with the coaxial connector of FIG. 10 using a threaded portion 930 of fluid adaptor 900 and the threaded portion 525 of the main nut 500. A tapered portion 925 of the fluid adaptor 900 seals against the conical portion 520 of the main nut 500. At this point, fluid may be injected to remove cable dielectric material 110 and inner conductor 105. Phantom lines around a front end 905 of the fluid adaptor 900 indicate a hydraulic fitting such as a quick disconnect or the like.

FIG. 14 depicts a schematic cross-sectional view of a tubing 1000, the packing nut 300 and the packing sleeve 400 introduced in preparation for engagement with the main nut 500, the back nut 600 and installed coaxial cable 100. As shown in FIG. 14, the coaxial cable 100 dielectric material 110 and inner conductor 105 have been ejected from the coaxial cable 100.

FIG. 15 depicts a partial cross-sectional view of a completed feed-through assembly in which the tubing 1000 has been inserted though the through-bore 315 of the packing nut 300, an opening 410 of the packing sleeve 400 and the inside of the outer conductor 115. In one embodiment, for example, the tubing 100 may be constructed from a polymer or other plastic material. Advancing the packing nut 300 by engaging the threaded portion 320 of the packing nut 300 with the threaded portion 525 of the main nut 500 drives a conical portion 310 of the packing nut 300 against a tapered portion 420 of the packing sleeve 400. Likewise, a tapered portion 425 of the packing sleeve 400 is driven against the conical portion 520 of the main nut 500. A ramp-like action of the conical and tapered surfaces described drives an opening 410 of the packing sleeve 400 radially inwardly and causes grooves/ridges 415 of the packing sleeve 400 to engage or grip tubing 1000 and prevents the tubing 1000 from experiencing unwanted movement. The example illustration of a completed feed-through assembly in FIG. 15 is shown as not having a ground wire installed.

FIG. 16 is a partial cross sectional view of a completed feed-through assembly of FIG. 15 having a ground wire 1050 installed in a bonding port 845 of the back nut 800 and secured with a set screw 870 within the threaded hole 835.

Attention will now be drawn to various example embodiments for feed-through connectors starting with FIG. 17. FIG. 17 depicts a cross-sectional view of a sub-assembly 605 in an uncompressed condition about a cable. The sub-assembly 605 comprises an actuator sleeve 7000, a ferrule 7500 and a back nut 610. In this embodiment, the ferrule 7500 is disposed within the sub-assembly 605 between tapered surfaces of the actuator sleeve 7000 and back nut 610 as shown in FIG. 17.

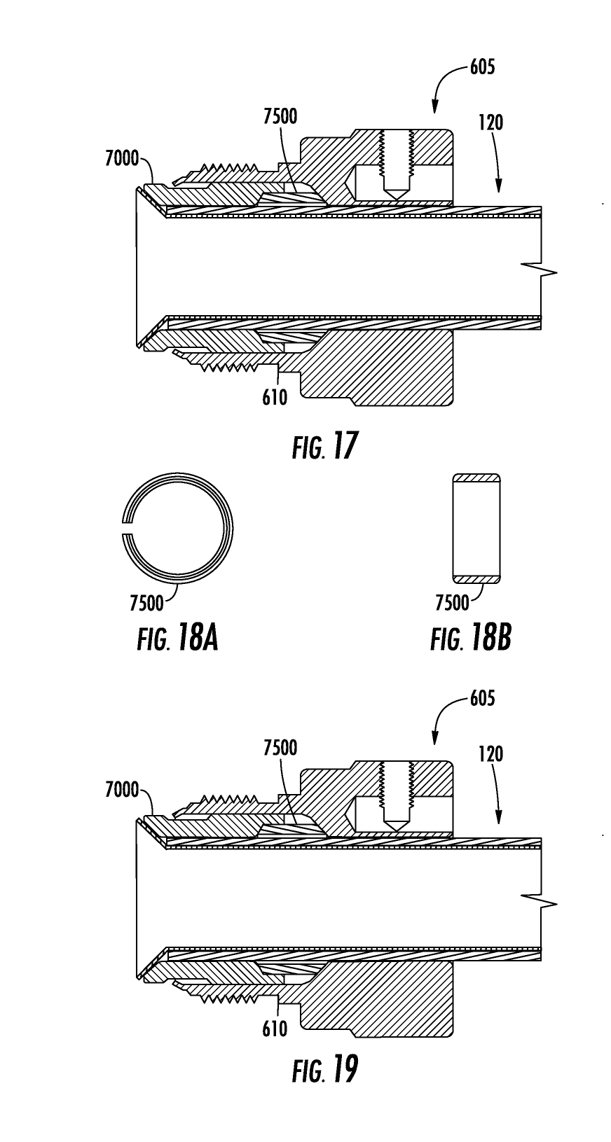

FIG. 18A is an end view of ferrule 7500 of FIG. 17. FIG. 18B is a cross sectional view of ferrule 7500 of FIG. 17. As shown in FIG. 18A, the ferrule comprise a generally circular, broken ring including an opening 7505. The opening 7505 of the ferrule 7500 allows for the ferrule to be compressed around a cable or tubing extending through an opening 7520 of the ferrule 7500 as opposing ends 7510 and 7515 are brought toward each other.

FIG. 19 depicts a cross-sectional view of the sub-assembly 605 of FIG. 17 in a compressed condition about a cable. In a manner similar to the functions described regarding FIG. 12, angled features of actuator sleeve 7000 and back nut 610 serve to compress ferrule 7500 radially inwardly to capture cable jacket 120.

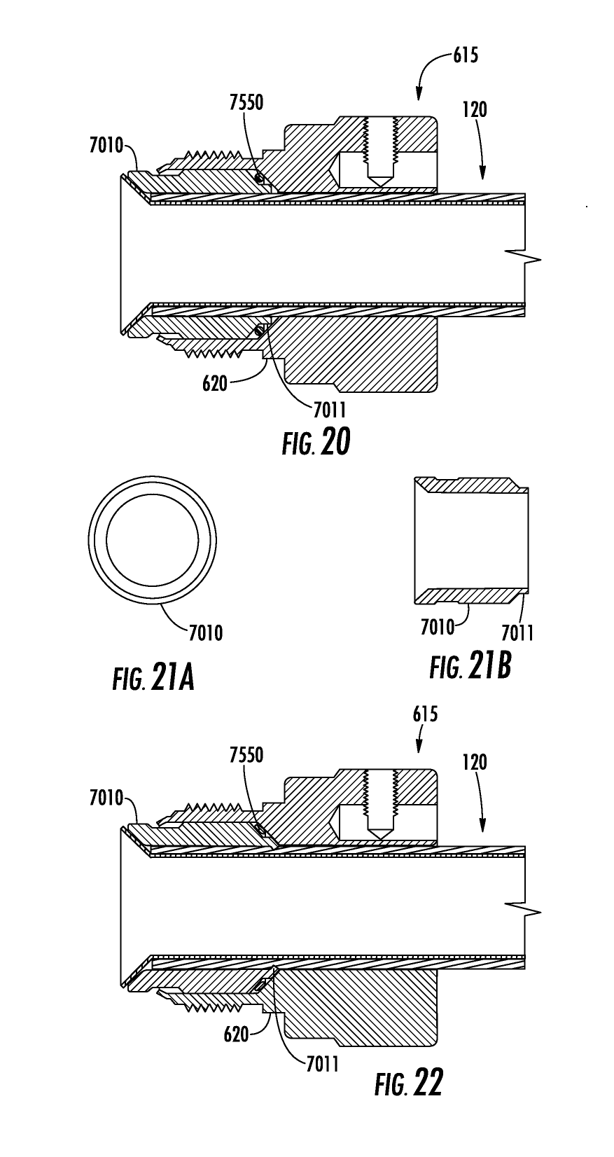

FIG. 20 depicts a cross-sectional view of an alternative embodiment of a sub-assembly 615 in an uncompressed condition about a cable. The sub-assembly 615 comprises an actuator sleeve 7010 having a lip 7011, and an O-ring 7550. The sub-assembly 615, however, may be constructed without the O-ring and/or with another sealing device.

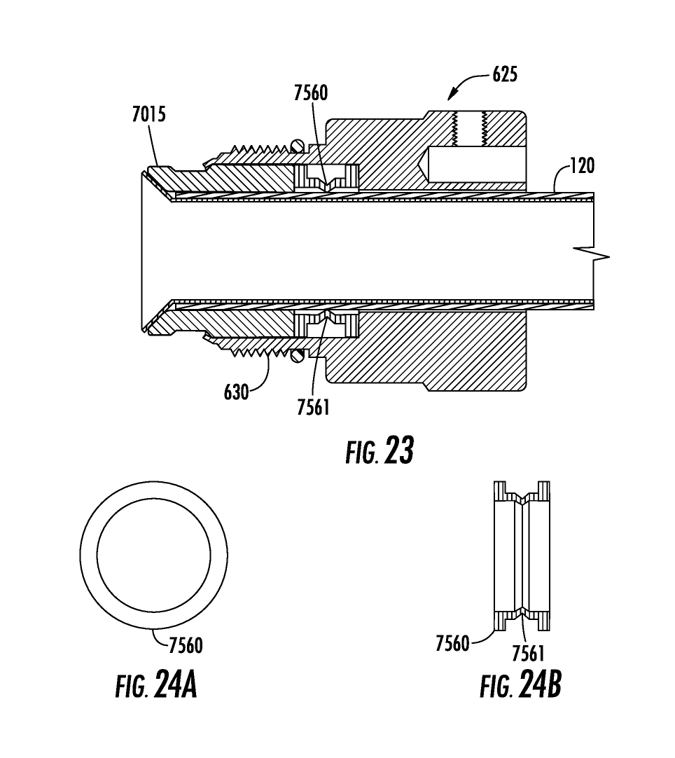

FIG. 21A depicts an end view of actuator sleeve 7010 of FIG. 20. FIG. 21B depicts a cross sectional view of actuator sleeve 7010 of FIG. 20. FIG. 22 depicts a cross-sectional view of the sub-assembly 615 of FIG. 20 in a compressed condition about a cable. In a manner similar to the functions described regarding FIG. 12, angled features of actuator sleeve 7010 and back nut 620 serve to compress a lip 7011 of the actuator sleeve 7010 radially inwardly to capture cable jacket 120. Optional O-ring 7550 serves to buffer or protect lip 7011 during shipping and handling and may further serve as an additional moisture barrier.

FIG. 23 depicts a cross sectional view of another embodiment of a sub assembly 625 in an uncompressed condition about a cable. The sub-assembly 625 comprises an actuator sleeve 7015 and a collapsible ring 7560. FIG. 24A depicts an end view of the collapsible ring 7560 of FIG. 23. FIG. 24B depicts a cross-sectional view of the collapsible ring 7560 of FIG. 23.

FIG. 25 depicts a cross-sectional view of the sub-assembly 625 of FIG. 23 in a compressed condition about a cable. In a manner somewhat similar to the connector described regarding FIG. 12, the actuator sleeve 7015 and the back nut 630 compress the collapsible ring 7560 in an axial manner driving shaped portion 7561 radially inwardly to capture cable jacket 120. Similar axial crushing/radial diameter reduction may be found in U.S. Pat. No. 5,525,076 by William Down, which is incorporated by reference in its entirety as if fully set forth herein.

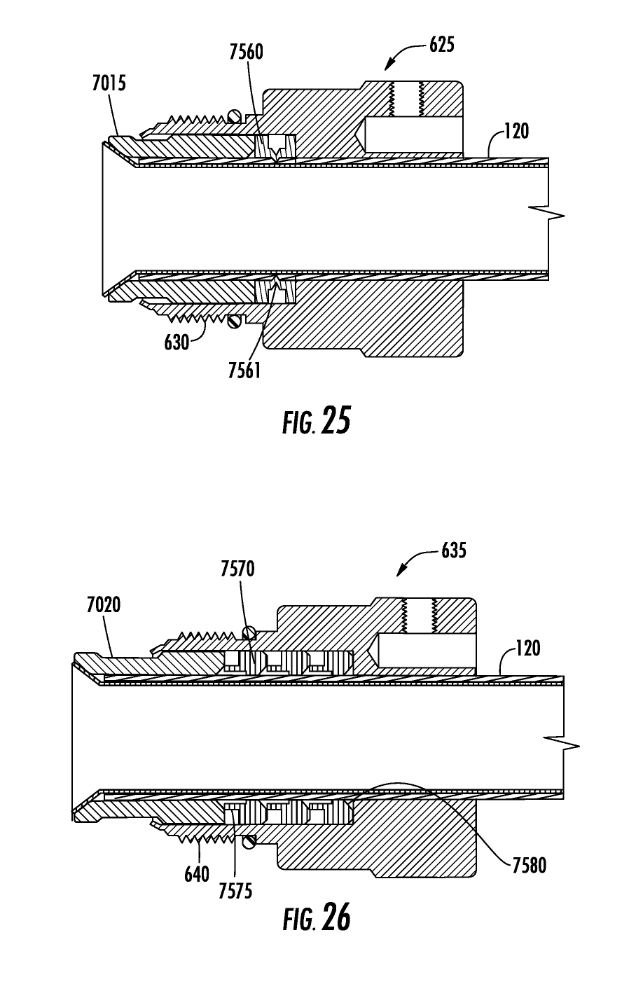

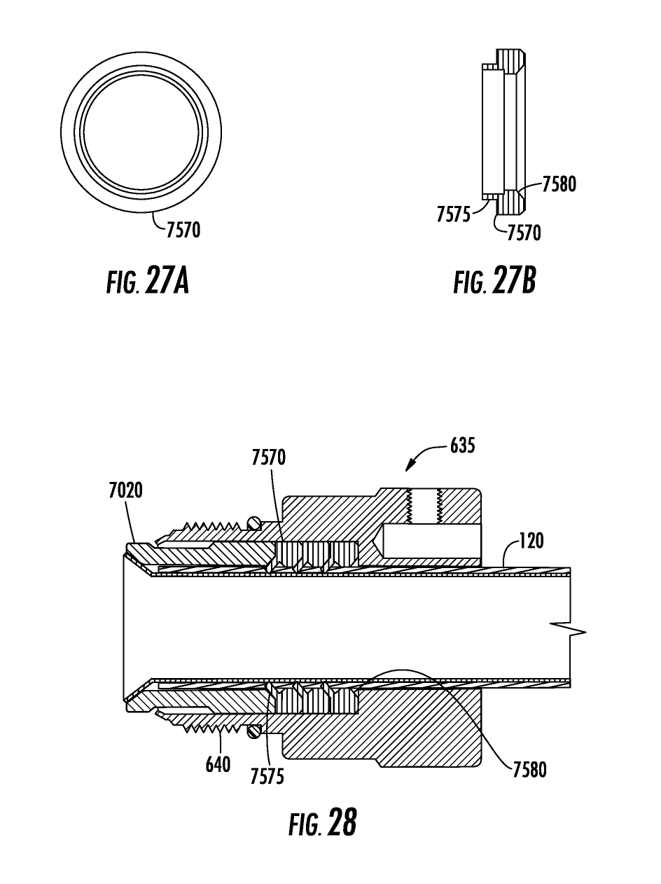

FIG. 26 depicts a cross-sectional view of another embodiment of a sub-assembly in an uncompressed condition about a cable. The sub-assembly 635 in this embodiment comprises an actuator sleeve 7020 and a plurality rings 7570 having a lip 7575 and a tapered portion 7580. FIG. 27A depicts an end view of the ring 7570 of FIG. 26. FIG. 27B depicts a cross-sectional view of the ring 7570 of FIG. 26.

FIG. 28 depicts a cross-sectional view of the sub-assembly 635 shown in FIG. 26 in a compressed condition about a cable. In a manner similar to the functions described regarding FIG. 12, the actuator sleeve 7020 and the back nut 640 serve to compress at least one ring 7570 driving lip(s) 7575 radially inwardly to capture a cable jacket 120 as previously described. In this embodiment, the ring(s) 7570 each have a tapered portion 7580 to co-act with the lip(s) 7575 of the successive ring(s) 7570. It should be understood that a single ring 7570 or a plurality of rings 7570 could be used.

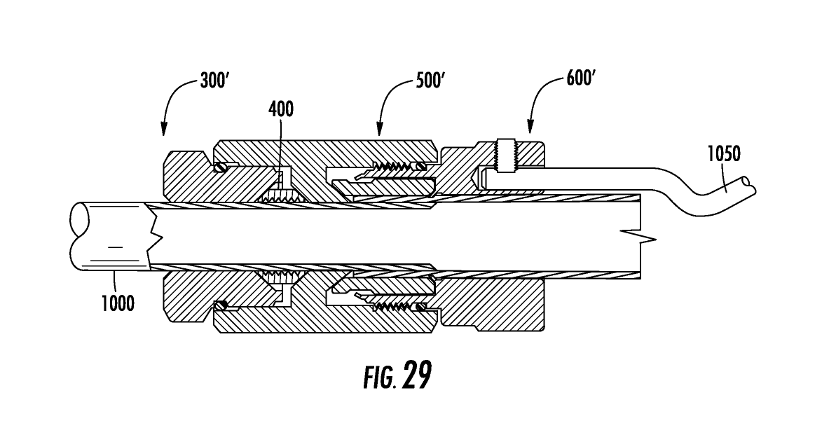

FIG. 29 depicts a partial cross-sectional view of an alternate embodiment of a completed feed-through connector assembly at least partially comprising polymer tubing 1000, packing nut 300′, packing sleeve 400, main nut 500′, and sub assembly 600′. This embodiment functions like that described in FIG. 12 through FIG. 16 with the exception that threaded portions on the packing nut 300′, the main nut 500′ and the sub-assembly 600′ are omitted. In this embodiment, the packing nut 300′, the main nut 500′ and the sub-assembly 600′ are axially driven together using a compression tool (not shown) and are retained by means of a press fit. This press-fit approach may also be applied to alternate embodiments previously described.

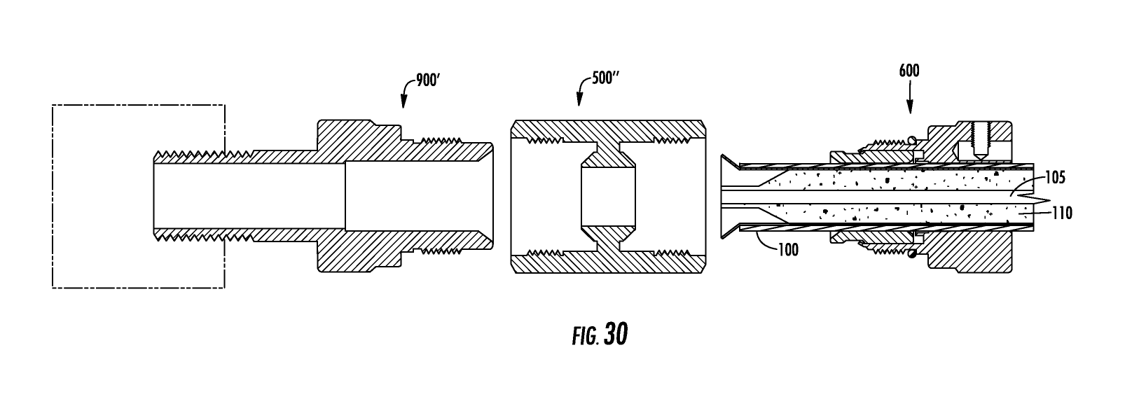

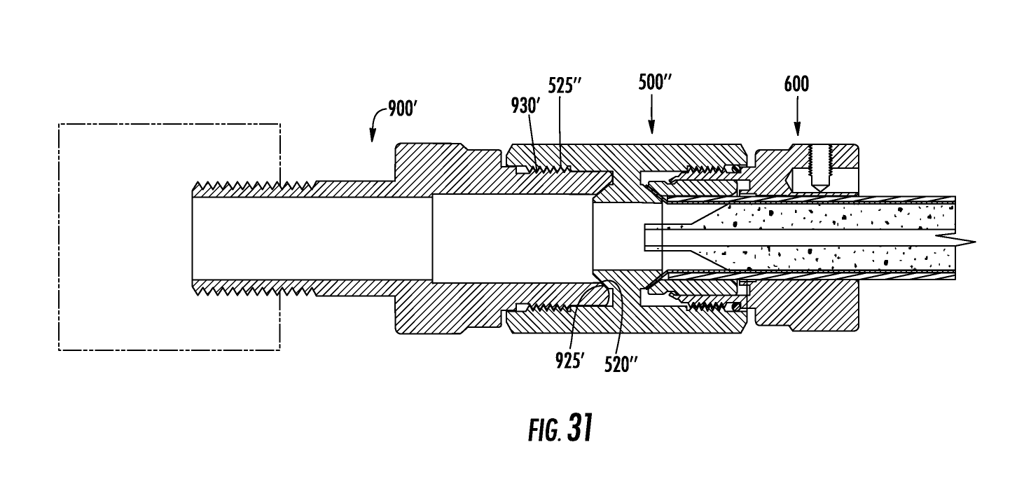

FIG. 30 depicts a cross-sectional view showing a sub-assembly 600 having a coaxial cable 100 inserted therethrough and the cable 100 has been prepared and flared. A splice main nut 500″ is introduced as is a fluid adaptor 900′ in preparation for a step of a process similar to that described for FIG. 11 through FIG. 13. In FIG. 30 the cable center conductor 105 and dielectric material 110 are still in place.

FIG. 31 depicts a cross-sectional view fluid adaptor 900′ engaged with the connection system of FIG. 30 by means of threaded portions 930′ of fluid adaptor 900′ and threaded portion 525″ of splice main nut 500″. Tapered portion 925′ of fluid adaptor 900′ seals against conical portion 520″ of splice main nut 500″. At this point, fluid may be injected to remove cable dielectric material 110 and inner conductor 105. Phantom lines around front end 905′ of fluid adaptor 900 indicate a hydraulic fitting such as a quick disconnect or the like.

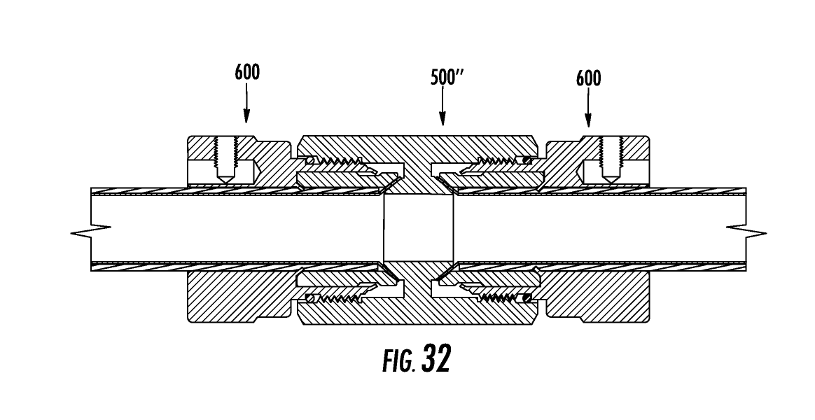

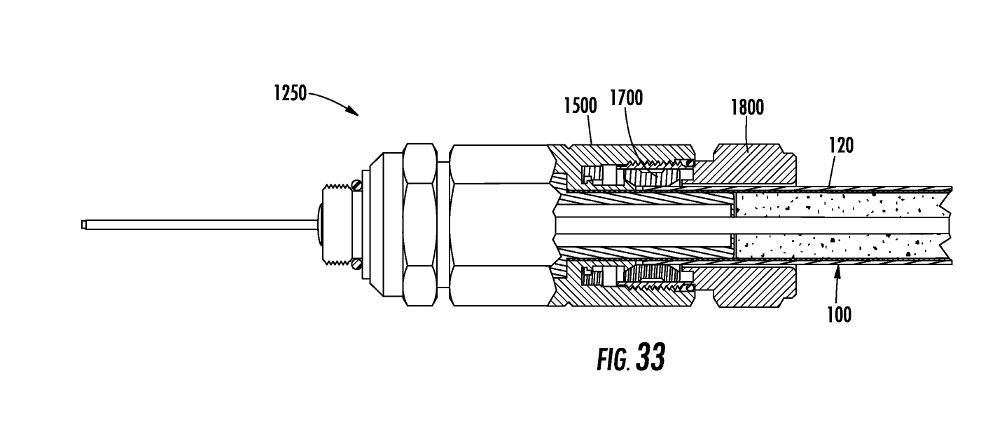

FIG. 32 depicts a partial cross-sectional view of a completed splice assembly comprising two sub-assemblies 600 and a splice main nut 500″ in which the sub-assemblies 600 interact with the splice main nut 500″ and the cable 100 in a similar manner as described with respect to FIG. 13.

FIG. 33 depicts a partial cross-sectional view of a three piece hardline coaxial pin type connector 1250 with having a jacket retention mechanism as described above with respect to FIGS. 4-10 in which a back coupler sleeve/nut is a not fully tightened condition. In this embodiment, the connector 1250 includes a front/main coupler sleeve/nut 1500, an actuator sleeve 1700 and a back coupler sleeve/nut 1800 similar to the components described with reference to FIGS. 4-10.

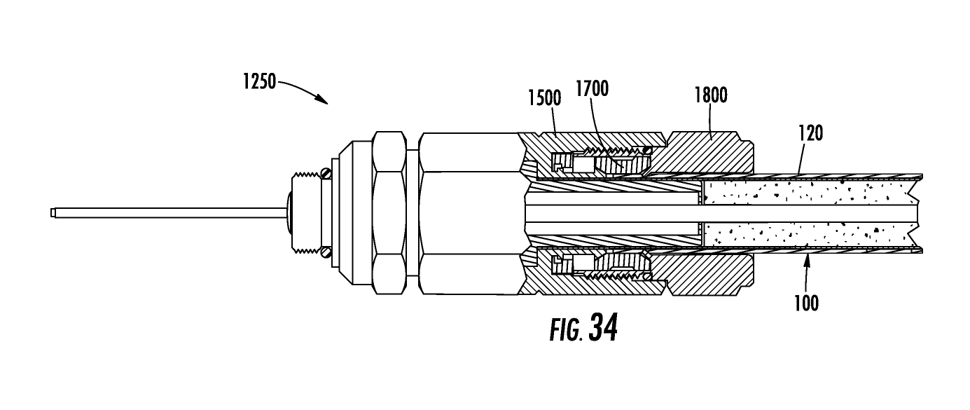

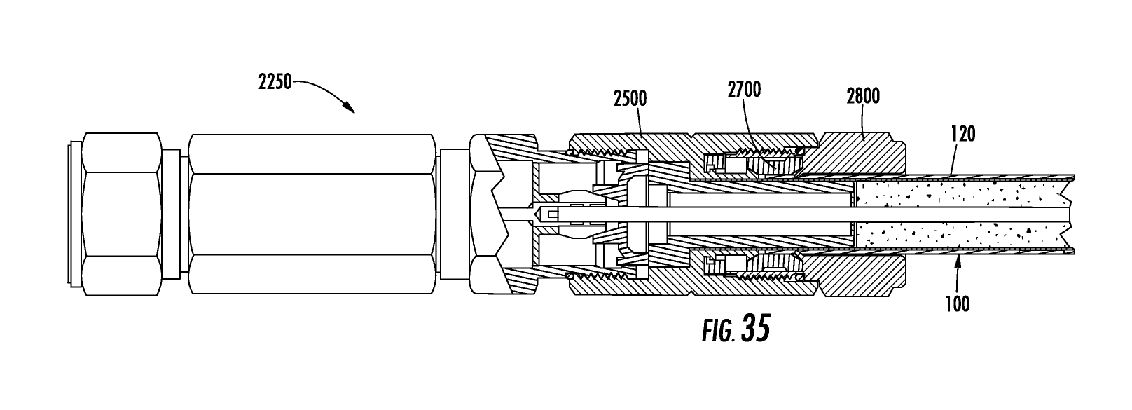

FIG. 34 depicts a partial cross-sectional view of the three piece hardline coaxial pin type connector 1250 shown in FIG. 33 with the jacket retention mechanism having a back nut in a tightened condition.

FIG. 35 depicts a partial cross-sectional view of a three piece hardline coaxial splice type connector 2250 with a jacket retention mechanism as described above with respect to FIGS. 4-10 in which a back coupler sleeve/nut is in a tightened condition. The connector 2250 includes a front/main coupler sleeve/nut 2500, an actuator sleeve 2700 and a back coupler sleeve/nut 2800 similar to the components described with reference to FIGS. 4-10.

It should now be understood that embodiments described herein are directed to connectors and methods for securing an outer layer of a cable or conduit within a connector.

For the purposes of describing and defining the subject matter of the disclosure it is noted that the term “substantially” is utilized herein to represent the inherent degree of uncertainty that may be attributed to any quantitative comparison, value, measurement, or other representation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

What is claimed is:

1. A connector for securing an outer surface of a cable or conduit, the connector comprising:
a back coupler sleeve comprising at least one inner surface defining a back coupler sleeve opening extending through the back coupler sleeve, an outer surface and an at least partially annular protrusion formed along the inner surface within the back coupler sleeve opening;
an actuator sleeve comprising an inner surface defining an actuator sleeve opening extending through the actuator and adapted to receive the cable, the inner surface including a tapered portion adapted to at least partially receive the at least partially annular protrusion of the back coupler sleeve within the actuator sleeve opening, the actuator sleeve inserted into the back coupler sleeve opening of the back coupler sleeve and disposed adjacent to the at least partially annular protrusion of the back coupler sleeve; and
a front coupler sleeve comprising an inner surface disposed about at least a portion of the outer surface of the back coupler sleeve and adapted to engage the outer surface of the back coupler sleeve,
wherein engagement of inner surface of the front coupler sleeve and the outer surface of the back coupler sleeve is adapted to displace the at least partially annular protrusion of the back coupler sleeve radially inwardly to secure the outer surface of the cable or conduit.

2. The connector of claim 1 wherein the cable connector is adapted to secure the outer jacket of at least one of a coaxial cable, a cored coaxial cable and a tube adapted to provide a conduit for receive one or more cables within an opening of the tube.

3. The connector of claim 1 wherein the front coupler sleeve comprises a front nut including a front coupler sleeve threaded portion disposed along the front coupler sleeve inner surface.

4. The connector of claim 3 wherein the back coupler sleeve comprises a back coupler sleeve threaded portion disposed along the back coupler sleeve outer surface and adapted to engage the front coupler sleeve threaded portion to axially displace the back coupler sleeve relative to the front coupler sleeve.

5. The connector of claim 1 wherein the inner surface of the front coupler sleeve defines a front opening and a back opening adapted to receive the back coupler sleeve, the front opening disposed on an opposing end from the back opening.

6. The connector of claim 5 further comprising a packing coupler sleeve and packing sleeve, the packing coupler sleeve comprising an outer surface adapted to engage with the inner surface of the front coupler sleeve defining the front opening of the front coupler sleeve and the packing sleeve adapted to be retained between the packing coupler sleeve and the front coupler sleeve.

7. The connector of claim 5 wherein the outer surface of the packing coupler sleeve comprises a packing coupler sleeve threaded portion adapted for threadably engaging a second threaded portion of the front coupler sleeve disposed on an inner surface of the front opening of the front coupler sleeve.

8. The connector of claim 6 wherein a through-bore connects the front opening and the back opening of the front coupler sleeve.

9. The connector of claim 8 wherein the packing sleeve comprises a tapered portion adapted to be driven against a conical portion of the through-bore of the front coupler sleeve.

10. The connector of claim 8 wherein the front opening, back opening and through-bore of the front coupler sleeve form a continuous opening through the front coupler sleeve.

11. The connector of claim 10 wherein the continuous opening is adapted to receive a tubing providing a feed-through assembly extending through the connector.

12. The connector of claim 1 wherein the back coupler sleeve comprises an axially extending port disposed extending from a back end of the back coupler sleeve.

13. The connector of claim 12 wherein a grounding wire is coupled to the back coupler sleeve within the axially extending port.

14. The connector of claim 1 wherein the actuator sleeve comprises a ferrule.

15. The connector of claim 1 wherein an outer surface of the actuator sleeve forms a recess adapted to engage a lip of the back coupler sleeve to restrict axial movement of the actuator sleeve with respect to the back coupler sleeve.

16. The connector of claim 1 wherein a collapsible ring is disposed between the actuator sleeve and the back coupler sleeve.

17. The connector of claim 1 wherein a plurality of rings are disposed between the actuator sleeve and the back coupler sleeve.

18. The connector of claim 1 wherein the at least partially annular protrusion comprises an annular ring extending from the inner surface of the back coupler sleeve.

19. A method for securing a cable or conduit in a connector, the method comprising:
inserting an actuator sleeve into an opening of a back coupler sleeve, wherein:
the back coupler sleeve comprises at least one inner surface defining the opening of the back coupler sleeve, an outer surface and an at least partially annular protrusion formed along the inner surface within the back coupler sleeve opening, and
the actuator sleeve comprising an inner surface defining an actuator sleeve opening extending through the actuator and adapted to receive the cable or conduit, the inner surface including a tapered portion adapted to at least partially receive the annular protrusion of the back coupler sleeve within the actuator sleeve opening, the actuator sleeve inserted into the back coupler sleeve opening of the back coupler sleeve and disposed adjacent to the annular ring of the back coupler sleeve;
extending a cable or conduit within the opening of the back coupler sleeve and the opening of the actuator sleeve; and
engaging at least a portion of the outer surface of the back coupler sleeve within an inner surface of a front coupler sleeve,
wherein the operation of engaging the inner surface of the front coupler sleeve and the outer surface of the back coupler sleeve displaces the at least partially annular protrusion of the back coupler sleeve radially inwardly to secure the outer surface of the cable or conduit.

20. The method of claim 19, wherein the operation of engaging comprises threadably engaging a back coupler sleeve threaded portion disposed along the back coupler sleeve outer surface and a front coupler sleeve threaded portion to axially displace the back coupler sleeve relative to the front coupler sleeve.

21. The method of claim 20 wherein the threaded engagement of the back coupler sleeve and the front coupler sleeve drives the at least partially annular protrusion radially inwardly along a contour of a tapered surface of the actuator sleeve causing the at least partially annular protrusion to circumferentially close about an outer surface of the cable or conduit.

22. The method of claim 19 further comprising coupling a fluid adaptor to the front coupler sleeve.

23. The method of claim 19 further comprising coupling a packing coupler sleeve and a coupler sleeve to the front coupler sleeve.
